(19) United States
(12) Patent Application Publication
(10) Pub. No.: US 2019/0358665 A1
(43) Pub. Date: Nov. 28, 2019

(54) GUIDE SYSTEM FOR DETECTION DEVICES

(71) Applicant: VERMES MICRODISPENSING GMBH, Otterfing (DE)

(72) Inventors: Mario FLIEß, München (DE); Jürgen STÄDTLER, Feldkirchen-Westerham (DE)

(73) Assignee: VERMES MICRODISPENSING GMBH, Otterfing (DE)

(21) Appl. No.: 16/486,451

(22) PCT Filed: Feb. 22, 2018
(86) PCT No.: PCT/EP2018/054406

§ 371 Date: Aug. 15, 2019

(30) Foreign Application Priority Data
Feb. 24, 2017 (DE) 10 2017 103 876.0

(51) Int. Cl. B05C 11/10; B05B 12/08; G01N 21/85

(52) U.S. Cl. CPC B05C 11/1034; B05B 12/082; G01N 2021/035; G01N 21/85; B05C 11/1013

(57) ABSTRACT

The invention relates to a guide system (1) for a detection device (3) for monitoring a substance (23) coming out of a nozzle orifice (5) of a metering device (2), wherein a nozzle orifice region (6) for arrangement at the nozzle orifice (5) is associated with the guide system (1), and the guide system (1) comprises at least one material body (15, 16) in which at least two guide ducts (7) are formed, which are designed to guide signal conductors (8) to the nozzle orifice region (6), wherein the end regions (14) of two guide ducts (7) facing the nozzle orifice region (6) are arranged, with regard to their central axes (9), substantially on a common straight line (G) relative to one another and are arranged, with regard to the nozzle orifice region (6), opposite one another. The invention further relates to a detection device (3) and to a metering device (2) having such a guide system (1) and to a method for configuring a detection device (3) having such a guide system (1).

The invention relates to a guide system for detection devices, in particular for metering devices. The invention further relates to detection devices or respectively metering devices provided with such a guide system and to a method for configuring a detection device having such a guide system.

In an introducing of metering substances, e.g. fluids or powders, by means of a metering device into a space, or an applying of metering substances by means of such a device onto a workpiece, for example in the applying of an adhesive, in particular for the fixing of electronic components by an automatic equipping system, it is necessary for the metering substance (e.g. the adhesive) to exit from the metering device through a nozzle in a well-metered manner. For example, it is desired here to be able to precisely carry out the metering of adhesive drops which are delivered in a well-defined manner along a trajectory onto a support, in order to guarantee a uniform quality, and in particular to take care that each adhesive drop or respectively adhesive dot is placed and any defects are indicated immediately.

To monitor the ensuring that a metering has taken place, preferably if applicable also the metered quantity, electromagnetic radiation can be used, which is guided up to the nozzle orifice by means of signal conductors. For example, light signals can be guided to this nozzle orifice and light signals can be guided from there again to a detection unit by means of light conductors, and the delivered drops (under certain circumstances even also the quantity of metering substance) can be deduced from a change in the signals.

An example for this is shown in EP 1 946 843 A1. Here, for the measuring of drops for liquids for life science applications, several light conductor detectors are used, which are situated at different distances from the nozzle along the trajectory of the drops. For positioning the light conductors, an elongated cylindrical small tube is arranged at or respectively before the nozzle, through which the straight-lined trajectory of the droplets runs along the longitudinal axis of the small tube. Radially-running through-bores are situated in the cylinder wall of this small tube at the desired positions, into which bores the light conductors are respectively inserted by their ends and fixed, e.g. glued in.

In several apparatuses in which metering devices are used, in particular in the above-mentioned equipping systems, a reliable guiding of the radiation or respectively of the signal conductors towards the nozzle is not, however, straightforward. Thus, for example, in SMT metering systems for assembly lines, on the one hand there is only very little space, and on the other hand the metering devices move relatively quickly in several superstructures in the system. In addition, external interference signals can also be present there. Hitherto, no optimum solutions are known.

Furthermore, applications are known for ink jet printers, in which measuring arrangements with light conductors are arranged respectively at a greater distance from the nozzles and laterally adjacent to the trajectory, which serve for the calibration of deflection arrangements for influencing the flight path of the drops, such as e.g. in U.S. Pat. No. 4,410,895. Here also, however, only the ends of the light conductors are fixed on the end side in a bore. In U.S. Pat. No. 4,577,197 a corresponding height control sensor for an ink jet printer is described which, for monitoring, is approached by the print head, therefore does not move with the latter. In addition, the light conductors which are used for supplying the light only need to be positioned relatively roughly, because the detection takes place by respectively a pair of photodetectors which are positioned directly at a mount in situ opposite the light conductor outlets. These systems therefore do not offer a solution for the problems mentioned.

It is an object of the present invention to provide an improved guide system and a corresponding detection device and a metering device and an improved method for configuring a detection device, in particular for SMT metering systems.

This problem is solved by a guide system according to claim 1, a detection device according to claim 13, a metering device according to claim 14 and a method for configuring a detection device according to claim 15.

The guide system according to the invention is designed for detection devices which is again suitable for the monitoring of a substance exiting from a nozzle orifice of a metering device, as is described above. A (virtual) nozzle orifice region for arrangement at the nozzle orifice is associated here with the guide system, or respectively the guide system has such a (virtual) nozzle orifice region. The guide system comprises here at least one material body, in which at least two guide ducts are formed. These guide ducts are designed to guide signal conductors of the detection device to the nozzle orifice region over a certain distance, i.e. not only—as in the mentioned prior art—to hold them at the end. The end regions of two guide ducts are arranged here, with regard to their central axes, substantially on a common straight line relative to one another and are arranged, with regard to the nozzle orifice region, opposite one another.

By means of the guide ducts it is ensured that the signals or respectively signal conductors are guided reliably in a correct manner to the nozzle orifice region and therefore to the nozzle orifice or respectively are guided away from there. Preferably, the guiding takes place over as long a distance as possible, e.g. of at least 10 mm, particularly preferably 20 mm or even more. This means that a guide duct e.g. accordingly also has the length. A correct positioning or respectively guiding makes the detection of drops exiting from the nozzle by means of the detection device more reliable. Signal conductors can—as explained later—be positioned in a simple manner at the nozzle orifice and can also be exchanged more easily.

The term “central axis” used with regard to a guide duct refers here furthermore to the axis which always follows the course of the guide duct, runs further in a straight line at the end regions and always runs similarly to the neutral axis (zero line) of a body with a symmetrical cross-section in the centre of the cross-section of the guide duct.

The region is designated as “nozzle orifice region” which is in a direct relationship to the position at which the nozzle orifice is situated in the case of arranging of the guide system on a metering device as intended. This region could also be designated as “nozzle orifice arrangement region”. The nozzle orifice region therefore also lies directly at the position at which the nozzle orifice lies in the case of arranging of the corresponding guide system on a metering device as intended, therefore relative to the nozzle as precisely as possible at the site of the nozzle orifice itself.

With regard to the nozzle orifice region, “opposite” means that the end regions are preferably substantially diametrically opposite. “Substantially” means here in particular that the maximum distance of the central axes of both opposite guide ducts from a substantially straight-lined emission direction, in which the metering substance, e.g. the drops, move out from the nozzle, is no more than the diameter, preferably no more than the radius, of the nozzle orifice as intended. Preferably, however, at least one of the central axes, preferably both central axes, intersect(s) the axis of this emission direction originating from the nozzle orifice (which emission direction could also be designated as “jetting trajectory”).

The designation “substantially” with regard to the arrangement of the central axes concerns here in particular the case where a sufficient signal conducting or respectively signal transmission also takes place in the case of signal conductors which are not precisely aligned.

With regard to the maximum displacement of the end regions of two guide ducts with respect to their central axes, “substantially on a common straight line relative to one another” preferably means that the cross-sectional area of the end region of each of the two guide ducts must be penetrated by the central axis of the respectively other guide duct (the central axis must meet the cross-sectional area) and particularly preferably the point of impingement of the respective central axis must not be more than one quarter of the diameter of the end region cross-section away from the central point of the respective cross-sectional area of the opposite guide duct.

With regard to the maximum tilting of the end regions of two guide ducts with regard to their central axes, “substantially on a common straight line relative to one another” preferably means that the central axes must be tilted by an angle not greater than 2° relative to one another, particularly preferably not more than 1° relative to one another.

The detection device according to the invention for monitoring a substance coming out of a nozzle orifice of a metering device has a signal transmitting unit, a signal receiving unit and a signal evaluating unit, as well as a guide system according to the invention.

Signals or signal conductors can run here through the guide ducts of the guide system. The signal transmitting unit can be arranged so that it can transmit signals through the guide ducts or the signal conductors, and the signal receiving unit can be arranged so that it can receive these signals which run through the guide ducts or the signal conductors.

The guide system according to the invention, just as also the detection device according to the invention as a whole, can be arranged at or on a metering device or can be arranged together with the latter on a common mount, so that the nozzle of the metering device is arranged with its nozzle orifice at the position of the nozzle orifice region of the guide system, in order to be able to carry out as correct a measurement as possible.

The metering device according to the invention comprises a guide system according to the invention or respectively a detection device according to the invention. The guide system according to the invention can therefore also be an integral part of the metering device.

The method according to the invention for configuring a corresponding detection device comprises at least the following steps:

A guide system is provided with which, as described above, a nozzle orifice region is associated for arranging on a nozzle orifice of the metering device, and which comprises at least one material body in which at least two guide ducts are formed, which are designed to guide signal conductors to the nozzle orifice region. The provision can take place so that in the construction of the metering device or respectively of a nozzle of the metering device, this guide system is installed or integrated together with it. However, it is also possible to retrofit already existing metering devices with such a guide system. This arrangement of the guide system therefore takes place so that the nozzle orifice region, as explained above, lies in a fitting manner at the nozzle orifice.

At least two signal conductors can then be inserted into the guide ducts of the guide system, so that the ends of the signal conductors are positioned in the end regions of the guide ducts. Thus, signals of the one signal conductor can pass the nozzle orifice through the air, and the light signals, if applicable in altered form, can then be captured in the other signal conductor. For this, the end regions of the guide ducts should lie in a fitting manner relative to one another, as is required with respect to the guide system according to the invention. It is preferred that in the case of a use of light conductors, these are stripped of their insulation in the region of their expected course in the guide ducts, and run in this stripped state in the guide ducts.

The signal conductors are connected at the end facing away from the nozzle with elements for measuring. Such an end of one of the signal conductors is thus connected with a signal transmitting unit, and the end, facing away from the nozzle, of another signal conductors is connected with a signal receiving unit. The signal transmitting unit can transmit signals through the one signal conductor for measuring. These cross through the space in front of the nozzle orifice as previously described, incide—if applicable modified or respectively modulated—into the other signal conductor and impinge on the signal receiving unit, which detects the signals and then makes these detected signals available for a further processing, in particular in an electronic manner.

The arrangement of the guide system at the further components of the metering device or respectively at a common mount can preferably take place here with already inserted light conductors, if applicable also together with the signal transmitting unit and/or the signal receiving unit. Preferably, this takes place with a quick coupling arrangement.

Further, particularly advantageous configurations and further developments of the invention will emerge from the dependent claims and from the following description, wherein the independent claims of one claim category can also be developed further in an analogous manner to the dependent claims and description sections of another claim category, and in particular also individual features of different example embodiments or respectively variants can be combined to new example embodiments or respectively variants.

The metering devices for which this invention is designed or which are part of the invention eject, as mentioned, a metering substance, e.g. a powder or a fluid, in a targeted manner through the nozzle orifice, preferably a viscous substance such as adhesive. This process can generally be designated as “emission” and is also designated below as “jetting” or similar. As the jetting can take place both on a trajectory (e.g. drop jet) and also as a conical or differently shaped drop distribution (e.g. a spray mist), the opportunity presents itself to introduce the term of the “resulting jetting direction”, which describes the emission trajectory or respectively the central straight line or respectively the mean value of the movement vectors of the drops of a conical or differently shaped jetting.

It is also practical for understanding to define a coordinate system for the metering device, in the origin of which the nozzle orifice lies and wherein the above-mentioned resulting jetting direction runs contrary to the Z-axis (the jetting trajectory then runs precisely opposed on the Z-axis). The X- and the Y-axis lie here on a plane orthogonally to the Z-axis. In the case where a cross-section of the metering device were to have a longer side in the X-Y plane, the X-axis is preferably defined so that it is aligned along this longer side and the Y-axis orthogonally thereto. The position of the nozzle orifice region, already defined above, at the position of the nozzle orifice as intended is then to be understood according to his coordinate system to be such that both the nozzle orifice and also the nozzle orifice region lie in the origin of this coordinate system.

According to a preferred embodiment, the guide ducts are surrounded at least partially, preferably however fully, on their surface areas by the wall, so that the signals or signal conductors are completely protected and e.g. light conductors can also be used without an additional casing.

A guide duct is continuously hollow here, in order to also be able to receive a signal conductor in an optimum manner. The face sides of the guide ducts can be closed, wherein this closure in this case must be penetrable for the signals. For example, transparent windows can allow light signals through. The face sides of the guide ducts are, however, preferably open.

The guide ducts preferably have a constant cross-section over their length at least up to the end regions. This has the advantage that signal conductors can be easily inserted into the guide ducts and thereby an equipping of the guide system with signal conductors or a replacing of signal conductors can be carried out easily.

The cross-sectional areas of the end faces of two guide ducts which are facing one another are preferably aligned orthogonally to their respective central axes.

According to an advantageous embodiment, the guide ducts can be configured so that they can serve as hollow conductors, therefore can themselves conduct electromagnetic waves according to the principle of hollow conducting. Thereby, no additional signal conductors would be necessary.

The cross-sectional area of the guide ducts preferably has the shape of a regular polygon, an ellipse or a circle. Ultimately, it is preferred that the cross-sectional shape of the guide ducts corresponds to that of the signal conductors or signal conducting paths as intended. This would permit a use of the established signal conductors, in particular conventional optical waveguides.

According to a preferred embodiment, at least a portion of a guide duct is formed as a recess in a material block. According to a further preferred embodiment, which can be combined in particular with the previous one, at least a portion of a guide duct is formed in a pipe. In a preferred combination of the two possibilities, a guide duct is formed partially in a pipe and partially in a material block. The pipe can additionally surround the casing present in the case of a light conductor or other signal conductor here, or replaces the latter, if applicable also only in sections and is not to be equated therewith.

In a preferred embodiment as a material block, the latter is divided into at least two segments (e.g. material block parts), the cut- or respectively fitting faces of which follow the alignment of the guide ducts and preferably separate these along the central axis. In this way, for example, a simple milling-in of the guide ducts is possible.

The material block can preferably be produced with the introduced guide ducts also in an additive manufacturing process, e.g. by means of a 3D printer.

In a preferred embodiment as a material block, the guide system has an orifice in the region of the nozzle orifice region, so that jetted drops can pass free of interference through the guide system in the nozzle orifice region or preferably a nozzle can be arranged in this orifice.

The edges of the opening are preferably configured so that inserted signal conductors or an arranged nozzle form there the lowest point with regard to the Z-coordinate defined above. This is preferably achieved with a conical inclination of the edges of the orifice. This simplifies a cleaning of the nozzle, e.g. by means of cleaning strips or cleaning swabs.

According to a preferred embodiment, at least one guide duct is stabilized in itself (i.e. the wall of the guide duct itself is formed so as to be firm and rigid) and/or by means of a number of stabilizing elements, so that the end region of the guide duct substantially does not move relative to the nozzle orifice region and preferably the guide duct also does not deform.

Lateral movements can bring about a misadjustment of signal conductors situated in the guide ducts or shearing forces in the signal conductors, which is suppressed through this embodiment.

A guide duct is preferably always so immobile that at least in the end region facing the nozzle orifice region, preferably the last 2 cm or respectively the last cm of the guide duct, in the case of a lateral force (i.e. transversely to the central axis of the guide duct) of 1 N is deflected no more than 1 mm from its original form, preferably no more an 0.1 mm.

In order to achieve a good rigidity, preferred materials for the walls of the guide ducts or respectively the guide system are materials of the group: plastic, metal, ceramic and glass.

The common straight line, on which the end regions of two guide ducts lie relative to one another with regard to their central axes, is preferably aligned orthogonally to the emission direction of the nozzle as intended. Thereby, an optimum arrangement is achieved in a detection device or respectively in a metering device.

The distance of the central axis of the end region of a guide duct, facing the nozzle orifice region, in particular each corresponding end region of an opposite guide duct pair from the nozzle orifice region, is preferably dimensioned with regard to the Z-coordinate so that it is no more than the internal diameter of the guide duct, preferably no more than ¾ of this internal diameter or even no more than half of the internal diameter. In this case, the signal conductor would overlap with the nozzle orifice with regard to a projection onto the Z-axis (or respectively a plane including the Z-axis) or would at least touch this with a point. Preferably, this distance in Z-direction from the nozzle is not greater than 1 mm, preferably not greater than 0.5 mm. This has the advantage that up to the measuring of the exit from the nozzle, a drop does not have to cover a large distance, which increases the accuracy of measurement and the placing of the drop.

Even when for some applications the signal conductors do not obligatorily have to be part of the device, nevertheless it can be advantageous if the signal conductors are part of the guide system and are arranged in the guide ducts. They can terminate flush with the guide ducts at the nozzle orifice region, however in another embodiment they can also protrude slightly. It can also be advantageous that they reach up to the nozzle orifice.

Preferred signal conductors are optical wave guides, e.g. glass fibres or polymer-based optical fibres, in particular with one or more of the following characteristics:
an external diameter of between 0.2 to 2.5 mm, preferably between 0.4 and 1.2 mm;
a permissible operating temperature of between −55° C. and 70° C., preferably up to 105° C.;
a maximum attenuation of less than 400 dB/km, preferably less than 210 dB/km, with a wavelength of 650 nm;
a numerical aperture of between 0.4 and 0.7.

In a further preferred variant, glass fibres are used which have one or more of the following characteristics:
an external diameter of between 0.2 to 1 mm, preferably between 0.25 and 0.7 mm;
a permissible operating temperature of between −65° C. and 70° C., preferably up to 125° C.;
a maximum attenuation of less than 20 dB/km, preferably less than 10 dB/km, with a wavelength of 650 nm;
a numerical aperture of between 0.3 and 0.5.

The internal diameter (or respectively the duct diameter) of the guide ducts should be greater than the external diameter of the signal conductors used as intended. Preferably, this internal diameter is greater than 0.01 mm, particularly preferably greater than 0.1 mm, than the external diameter of the signal conductor, in order to enable an easy inserting of the signal conductors through the guide ducts. Preferably, the difference between the internal diameter of the guide ducts and the external diameter of the signal conductors is less than 0.5 mm, particularly preferably less than 0.15 mm, in order to prevent an uncontrolled lateral displacing of an inserted signal conductor. Preferred internal diameters lie between 0.1 mm and 10 mm.

The internal diameter of a guide duct in the end region facing the nozzle orifice region, preferably maximally in the region of the last approximately 0.5 to 2 cm of the end region, is preferably smaller than the internal diameter of the remaining guide duct, but greater than the external diameter of the signal conductors used as intended. Preferably, this internal diameter is at least 0.005 mm, particularly preferably at least 0.05 mm, greater than the external diameter of these signal conductors, in order to enable an inserting, but preferably maximally 0.2 mm, particularly preferably maximally 0.09 mm, greater than this external diameter, in order to achieve a precise positioning of an inserted signal conductor.

The end region of a guide duct, facing the nozzle orifice region, can also preferably have an elastic layer within the last cm, on the inner side of its wall. The internal diameter of the duct can then preferably correspond there maximally to the external diameter of the signal conductor as intended or can even be up to 0.1 mm smaller, wherein the signal conductor can of course still be pushed through. This has the advantage that an inserted signal conductor is held by the elastic wall and is stabilized.

All signal conductor external diameters relate respectively to the state of the signal conductors, as they are inserted into the guide ducts, i.e. when they are inserted with a casing, this applies to the external diameter of the casing or, when they are inserted with the casing removed, this applies to the external diameter of the signal conductors with the casing removed.

According to a preferred embodiment, the guide system, the detection device or the metering device have in addition fixing elements for fastening a signal transmitting unit and a signal receiving unit. The fixing elements are preferably arranged relative to the guide ducts so that the signal transmitting unit and the signal receiving unit are able to be connected with the respective signal conductors exiting from the guide ducts. For example, LEDs/laser diodes and photodiodes or similar can be fastened therewith.

According to a preferred embodiment, the guide system, the detection device and/or the metering device comprise a coating, at least in the region of a guide duct, preferably a coating with a lower frictional resistance than the base material of the wall, and/or a coating with a greater hardness than the base material of the wall. Preferably, the coating comprises materials from the group: Teflon, graphite, diamond, nickel, carbide, aluminium oxide, ceramic and glass.

Preferably, the guide system has a strain relief for a signal conductor arranged in a guide duct. Such a strain relief is preferably situated in an end region of the guide duct remote from the nozzle orifice.

The strain relief can comprise here at least one arresting element for arresting the signal conductor in the guide duct. Preferably, the arresting element brings about a blocking of the drawing out and pushing in of the signal conductors with respect to the guide duct. Preferably, the strain relief can take place by means of arresting elements in the form of screws and/or clamping elements, particularly preferably elastic and/or spring-loaded clamping elements. The arresting elements can preferably also be formed as push-buttons which, on being pressed down, permit a pushing of signal conductors, and on releasing block a movement. Preferably, the guide system has elements here which prevent an unintentional releasing of the arresting elements from the guide system.

Particularly preferably, this strain relief can be configured so that a signal conductor casing can be fixed, in particular clamped, thereon. A tension on the encased signal conductor outside the guide duct then generally has a weakened, advantageously even no, effect on the position of the part with casing removed, or respectively core, of the signal conductor which is inserted into the guide duct.

Alternatively or additionally, the end region of a guide duct, facing the nozzle orifice region, can also be configured as a type of strain relief. For example, this end region can be configured as a type of slotted duct or respectively as a slotted small tube, wherein the slot width can be further reduced slightly after the introducing of the light conductor, in order to clamp the light conductor therein. Preferably, such a clamping takes place on at least a length of approximately 0.5 cm.

The guide system is preferably configured so that the guide ducts, in a mounted state on the metering device, run on the same side on the metering device on which the signal transmitting unit and the signal receiving unit of the detection device are also arranged. Thereby, a better accessibility, in particular in the case of repairs etc., can be realized.

A guide duct or respectively the guide ducts are preferably curved, i.e. they have curves, along which the respective light conductor is then guided in the guide duct. Curves in a guide duct are preferably configured so that they do not fall below the minimum bending radius, as intended, of the signal conductor which is provided for this guide duct. Preferred bending radii are greater than 5 mm, preferably greater than 15 mm. For space-saving reasons, preferred bending radii are less than 120 mm, preferably less than 80 mm.

Preferably, at least one guide duct, particularly preferably each of at least two guide ducts, has here two adjacent curves. These curves can—according to the practical formation and spatial arrangement of the metering device—preferably be situated in a plane, preferably in the manner of an S-curve, or in two spatial planes which are tilted relative to one another. A curving arrangement is advantageous in any guide systems for a detection device for the monitoring of material coming out of a nozzle orifice of a metering device, which have a nozzle orifice region for arrangement at the nozzle orifice and comprise at least one material body, in which at least two guide ducts are formed, which are designed to guide signal conductors of the detection device to the nozzle orifice region. This applies therefore not only in the arrangement according to the invention, in which the end regions of the two guide ducts are arranged, with regard to their central axes, substantially on a common straight line relative to one another and are arranged, with regard to the nozzle orifice region, opposite one another, even though this combination is particularly advantageous. In this respect, the curve arrangement of the guide ducts can, however, also be advantageous independently.

Curves are preferred respectively in which the course of the central axis changes in an angle between 15° and 135°, preferably by 90° (if applicable with a deviation of maximally+/−20%).

In so far as the curves are situated in a plane, e.g. in a type of S-curve, as regards amount the angles are preferably substantially identical but mirror-inverted, i.e. the course of the guide duct is shifted in a parallel manner through the curve formation in the plane.

In so far as the curves are situated in two spatial planes which are tilted relative to one another, the two spatial planes are most particularly preferably inclined relative to one another in an angle between 45° and 135°. Preferably, they stand substantially orthogonally (if applicable with a deviation of maximally+/−20%) relative to one another.

In particular when the curves lie in two spatial planes which are substantially orthogonal relative to one another, the curve which lies nearest to the end region of the guide duct preferably runs in a plane which is aligned orthogonally to the emission direction of substance exiting from the nozzle, and the curve adjacent thereto preferably runs in a plane parallel to this emission direction. Observing the coordinate system which was described above, then the curve which lies nearest to the end reaction facing the nozzle orifice region preferably runs in a plane which is tilted by up to 20°, preferably up to 15°, particularly preferably approximately 11° to the X-Y plane. This tilting takes place here preferably about the common straight line (of the central axes of the end regions of the guide ducts), in the direction of the ends of the guide ducts remote from the nozzle. The configuring can thus be particularly space-saving. However, it is also theoretically possible that the plane of this curve, close to the nozzle, runs in the X-Y plane. The curve adjacent thereto then preferably runs in a plane parallel to the Z-axis. In particular, this has the advantage of a reduction of tensions in the signal conductor and a better signal transmission.

The guide system or respectively a detection device comprising this guide system preferably has a quick coupling arrangement for the mounting of the guide system or respectively of the detection device on a further component (for example a nozzle block or suchlike) of a metering device. This quick coupling arrangement is particularly preferably configured so that it is able to be actuated in a tool-free manner, i.e. that an operator can mount the guide system or respectively the detection device on a further component of the metering device quickly and without a tool, and can remove it again. In the case of a fault, a particularly quick reestablishment of the functional capability of the detection device or respectively metering device can thus be achieved.

This can be realized for example by means of a clamping arrangement with which the guide system can be clamped on the component of the metering device, for example in the manner of a vice.

It is preferred that the quick coupling arrangement has elements of the group: guide holes, guide pins, screw threads and screws. In particular knurled screws are preferred, because these enable an easy loosening of the screw connection and/or clamping connection without a tool. The pins and arresting holes are preferably arranged here so that, with a correct positioning of the nozzle orifice region at the nozzle orifice, they engage into one another in a form-fitting manner or respectively the threads and screws are preferably arranged accordingly, that with a correct positioning of the (virtual) nozzle orifice region of the guide system at the nozzle orifice a screw connection or clamping can be brought about.

The quick coupling arrangement for a realization in the form of a clamping arrangement can preferably comprise at least one holding element, e.g. a clamping jaw, a retaining finger or suchlike. In addition, the guide system can also comprise a particular forming of at least one pipe portion or of a part of a material block, e.g. for the formation of a clamping jaw or suchlike. The guide system could then be clamped with the said component of the metering device by the tightening of a screw or of another fastening element. Particularly preferably for this a portion of the guide system with the quick coupling arrangement is configured so that a structure of the metering system or respectively its component can be at least partially comprised.

According to a preferred embodiment, the detection device is configured as a drop detection arrangement for the detection of drops exiting from a nozzle. In addition, the detection device has the following features:
a signal transmitting unit, which is arranged to generate a carrier signal with a defined pulse frequency,
a modulation unit, which is arranged to generate a modulated measurement signal through a physical interaction of the carrier signal with a drop which is to be detected,
an evaluating unit, which is arranged to determine, taking into account the defined pulse frequency on the basis of the measurement signal, whether a drop was delivered from the nozzle.

The drop detection arrangement is preferably configured so that a delivery of a drop is checked in a defined time window, which is synchronized with a drop delivery control of the nozzle. It preferably has a demodulation unit, which is arranged to carry out an amplitude demodulation of the measurement signal and/or a quadrature demodulation of the measurement signal, in order to determine an in-phase component and a quadrature component.

The evaluation unit preferably comprises a modulation value determining unit, which is arranged to determine, preferably on the basis of the in-phase component and the quadrature component, the amount of the amplitude and/or the phase of a modulation signal based on the modulated measurement signal.

Preferably, the modulation determining unit is arranged to determine amplitude derivative values (dA/dt), comprising the time derivative of the amount of the amplitude, and/or phase derivative values (dφ/dt), comprising the time derivative of the phase of the modulation signal, wherein preferably in a fixed time interval a predetermined number of the amplitude derivative values (dA/dt) are combined to amplitude comparative values and/or a predetermined number of the phase derivative values (dφ/dt) are combined to phase comparative values, or in a fixed time interval a predetermined number of maximum values of the amplitude derivative values (dA/dt) are combined to amplitude comparative values and/or a predetermined number of the maximum values of the phase derivative values (dφ/dt) are combined to phase comparative values. Here, the evaluating arrangement preferably comprises a detection filter unit which is arranged to determine, on the basis of the amplitude comparative values and/or of the phase comparative values, whether the modulation signal indicates a drop, wherein the detection filter unit is preferably arranged to determine a relative deviation of an amplitude comparative value, determined by the modulation value determining unit, from an amplitude reference value, and/or a relative deviation of a phase comparative value, determined by the modulation value determining unit, from a phase reference value.

Preferably, the drop detection arrangement has a reference value storage arrangement, in which an amplitude reference value, which is formed from a plurality of amplitude comparative values of previously detected modulation signals, and/or a phase reference value, which is formed from a plurality of phase comparative values of previously detected modulation signals, are stored as variable reference values.

Preferably, the detection filter unit is arranged to determine whether the determined relative deviation of the amplitude comparative value from the amplitude reference value and/or the determined relative deviation of the phase comparative value from the phase reference value do not exceed a relative lower and upper threshold value, or respectively the detection filter unit is preferably arranged to determine whether the absolute amplitude reference value used for the determining of the deviation of the amplitude comparative value lies in a predetermined absolute amplitude reference value interval and/or whether the absolute phase reference value used for the determining of the deviation of the phase comparative value lies in a predetermined absolute phase reference value interval.

Particularly preferably, the modulation unit comprises a light emission unit and a light sensor unit and/or a capacitive sensor unit. The signal transmitting unit is preferably arranged to generate a rectangular signal as carrier signal.

According to a preferred embodiment, the detection device for the detection of drops coming out of a nozzle and moving along a trajectory, has the following elements:
an optical wave guide arrangement as signal conductor with a first optical wave guide and with a second optical wave guide, which are arranged opposite one another at an intermediate space through which the trajectory of the drop runs, such that a light beam emitted from the first optical wave guide crosses the trajectory of the drop and is subsequently coupled into the second optical wave guide,
a light signal transmitting unit, in order to couple into the first optical wave guide a light beam pulsed with a carrier frequency,
a light evaluating arrangement, in order to evaluate the light beam coupled into the second optical wave guide, in order to determine whether a drop was delivered from the nozzle.

Preferably, the first optical wave guide has here a first and a second end, wherein the first end of the first optical wave guide is coupled with a light emission arrangement of the light signal transmitting unit, and the second end of the first optical wave guide forms an emission window to the intermediate space which is to be monitored. Likewise, the second optical wave guide has a first and a second end, and the first end of the second optical wave guide then forms a detection window to the intermediate space which is to be monitored, and the second end of the second optical wave guide is coupled with a sensor arrangement of the light evaluating arrangement.

The optical wave guides are preferably arranged at the nozzle such that the pulsed light beam from the first optical wave guide impinges directly onto the drop, is modulated by the drop and is coupled directly into the second optical wave guide. The first optical wave guide and the second optical wave guide preferably comprise plastic fibres.

Preferably, the optical wave guides and thereby the guide ducts are positioned relative to the nozzle (or respectively to the nozzle orifice region), such that a defined effective cross-sectional area of the first and/or second optical wave guide is provided as a function of the respective metering process, in particular as a function of a drop size which is to be expected.

The light evaluating arrangement is preferably arranged to determine, taking into account a defined carrier frequency of the pulsed light beam, whether a drop was delivered from the nozzle.

The drop detection arrangement preferably comprises a demodulation unit, which is arranged to carry out an amplitude demodulation or a quadrature demodulation of a detected modulated measurement signal on the basis of the pulsed light beam.

The light evaluating unit preferably comprises a modulation value determining unit, which is arranged to determine, preferably on the basis of an in-phase component and a quadrature component, the amount of the amplitude and/or the phase of a modulation signal based on the modulated measurement signal.

Preferably, the light emission arrangement is arranged to convert a pulsed electrical signal into a light wave, without altering the carrier frequency and phase of the pulsed signal to a relevant extent (see above).

The light signal transmitting unit is preferably formed so that the brightness of the pulsed light beam is adjusted via the selection of a pulse width of light pulses of the pulsed light beam.

Such preferred detection arrangements are described in detail in DE 10 2015 117 246 and DE 10 2015 117 248, the content of which is incorporated herewith in this respect.

According to the present invention, however, the signals or respectively signal conductors (e.g. the light conductors) are guided here to the nozzle orifice through the guide ducts of the guide system according to the invention.

In an arrangement without introduced signal conductors, the guide ducts are configured so that these can be introduced as described above.

The invention is explained again in further detail with reference to the enclosed figures with the aid of example embodiments. Here, the same components are provided with identical reference numbers in the various figures. The figures are generally not to scale. There are shown respectively:

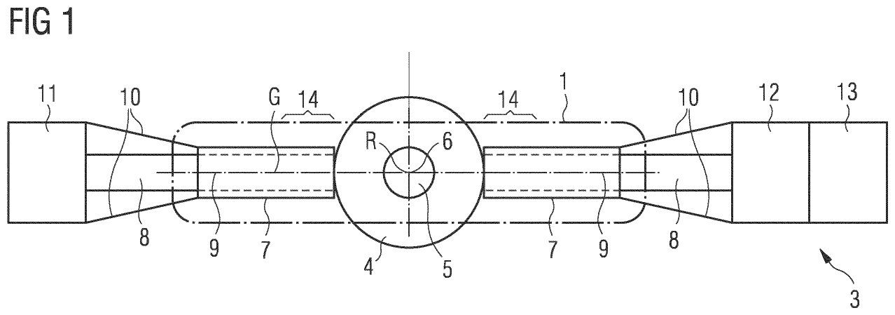

FIG. 1 a diagrammatic illustration of a preferred guide system in a preferred detection device,

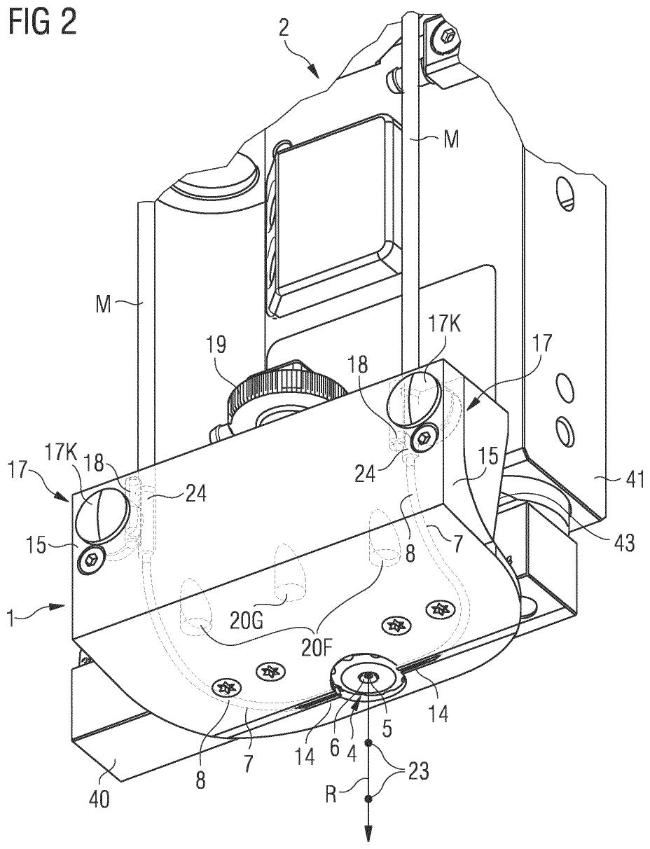

FIG. 2 a preferred example embodiment of a metering device with a preferred example embodiment of a guide system,

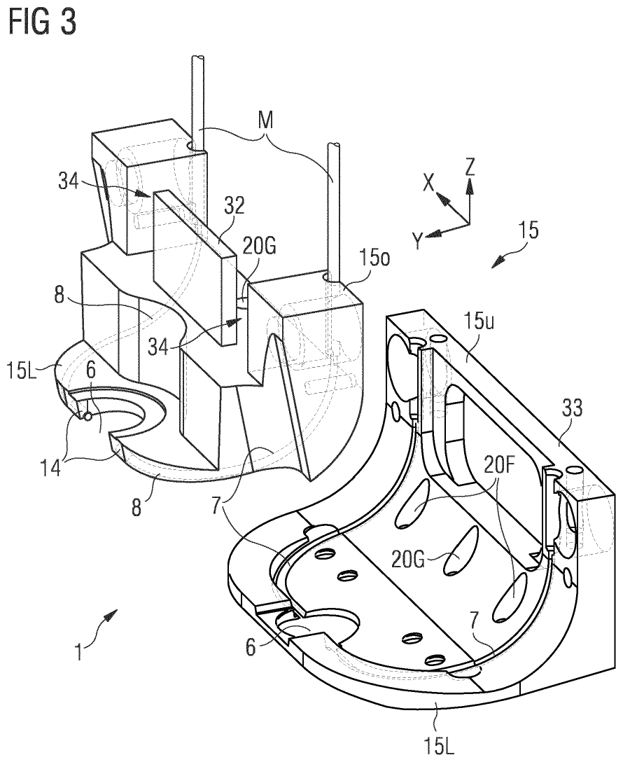

FIG. 3 the guide system according to FIG. 2 in the form of an exploded view,

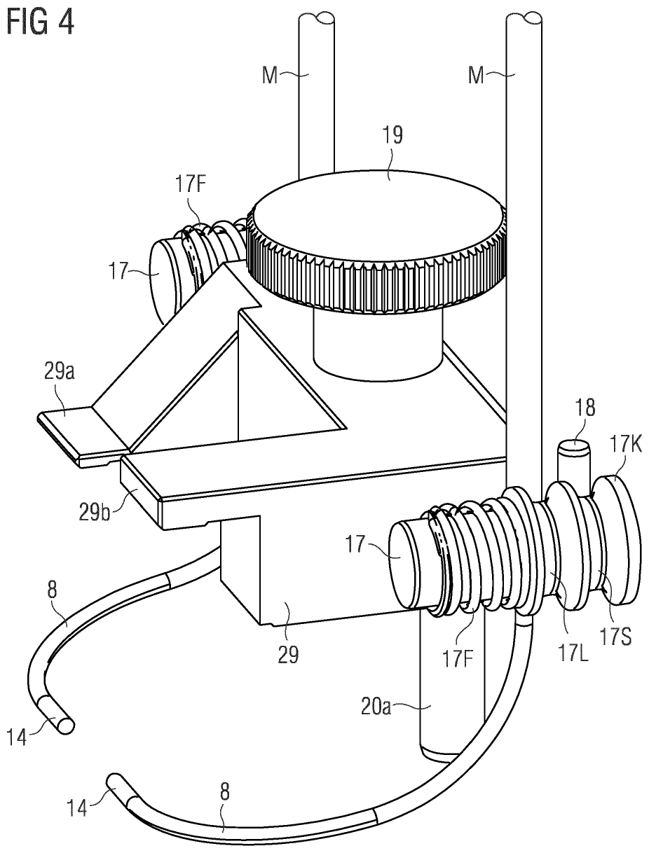

FIG. 4 details of the guide system according to FIGS. 2 and 3,

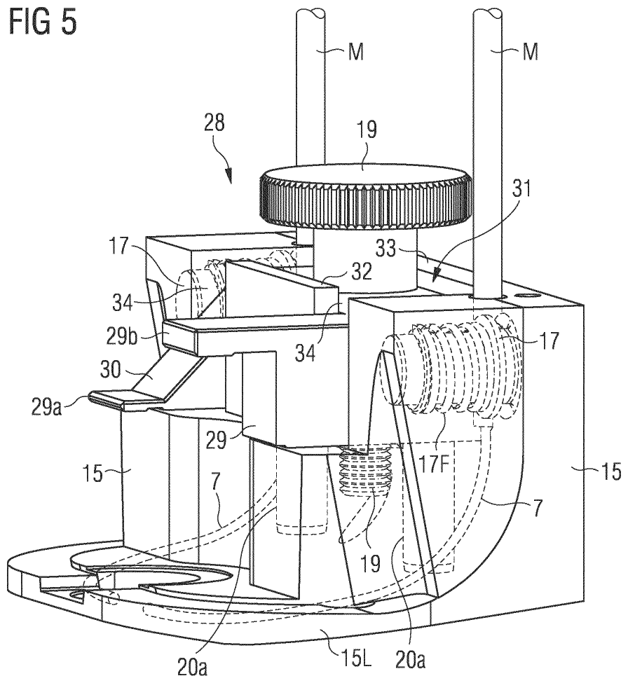

FIG. 5 further details of the guide system according to FIGS. 2 and 3, to illustrate a quick coupling arrangement for arranging the guide system on a metering device,

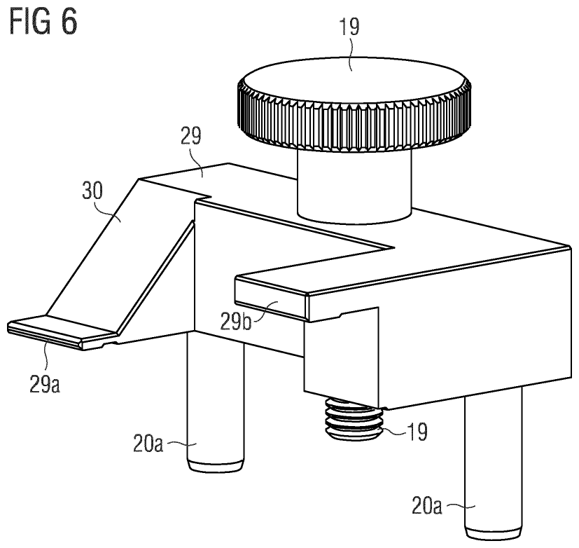

FIG. 6 further details regarding a clamping jaw of the quick coupling arrangement of the guide system according to FIG. 5,

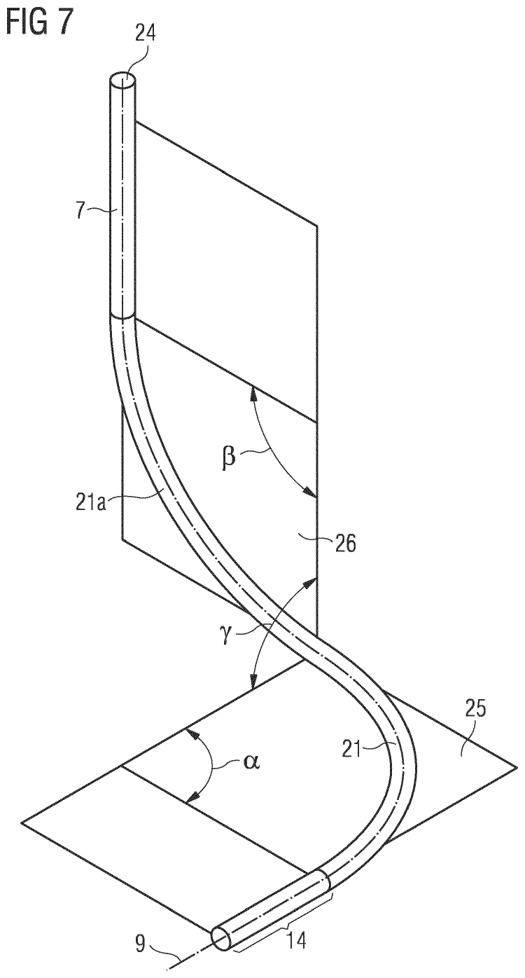

FIG. 7 a diagrammatic illustration of a preferred arrangement of curves in a guide duct of the guide system according to FIGS. 2 and 3,

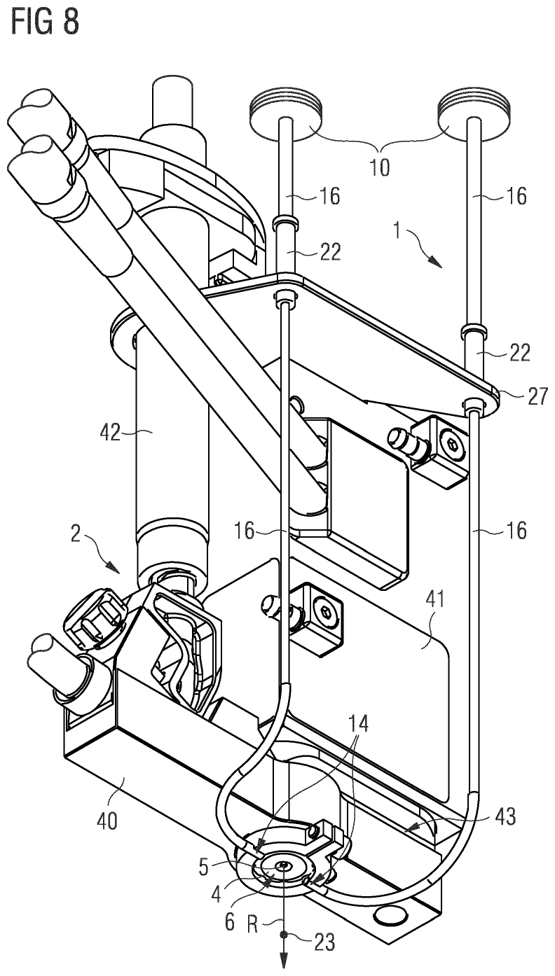

FIG. 8 a further preferred embodiment of a guide system on a metering device,

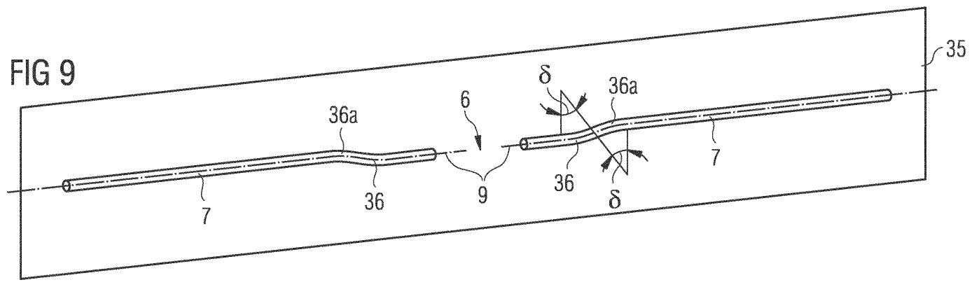

FIG. 9 a diagrammatic illustration of a further preferred arrangement of curves in guide ducts of an example embodiment of a guide system according to the invention.

FIG. 1 shows in a rough diagrammatic manner an arrangement of a preferred example embodiment of a guide system 1 in a preferred detection device 3. A nozzle 4 which is part of a metering device 2 is illustrated in top view. This can be configured for example in the manner as it is later explained with the aid of FIGS. 2 and 8. By means of the nozzle 4, for example drops of a metering substance 23 (see FIG. 2) or medium, e.g. adhesive, can be jetted or respectively metered.

In FIG. 1 the view is directed from below onto the nozzle 4, so that jetted drops would move out from the plane of the drawing, i.e. the emission direction R points out from the plane of the drawing. This view is intended merely to illustrate the function and arrangement of the most important components in relation to one another. The lengths and shapes of individual components are not realistic in this illustration.

The nozzle 4 has a nozzle orifice 5, from which the medium leaves the nozzle. At the position of the nozzle orifice 5, the (only virtual) “nozzle orifice region” 6 of the guide system 1 is arranged, which in the absence of the nozzle 4, therefore e.g. in the case of a guide system 1 not arranged on a metering device 2, represents the reference region for the guide ducts 7. The guide ducts 7 are arranged on two sides lying opposite one another, which guide ducts in particular can be present in pipes or can be milled-out portions in a material block, as is shown further later. Its central axis 9 lies centrally in each guide duct 7.

In FIG. 1 an arrangement can be seen in which the two guide ducts 7 are exactly diametrically opposite one another with regard to the nozzle orifice 5 or respectively the nozzle orifice region 6. The two central axes 9 run here between the ends of the guide ducts 7 on a common straight line G and would meet the respective opposite guide duct 7 centrally. This straight line G runs perpendicularly through the emission direction R.

Signal conductors 8 which extend up to the nozzle 4 are introduced in the guide ducts 7. They can terminate flush with the guide ducts 7 at the nozzle 7, but can also—as shown here—protrude slightly. Theoretically, they can also extend up to the nozzle orifice 5. The signal conductors 8 together with the guide system 1 (or respectively as part thereof), if applicable with fixing elements 10, with a signal transmitting unit 11, with a signal receiving unit 12 and with a signal evaluating unit 13, constitute a preferred detection device 3 (or respectively a detection system 3). It should be noted that FIG. 1 only sketches the detection device 3 very roughly. In practice, it would be a great advantage to arrange the electronic elements further remotely from the nozzle orifice 5, and to configure the guide ducts 7 and the signal conductors 8 to be longer.

FIG. 2 shows a preferred metering device 2 with a nozzle 4, which has a nozzle orifice 5. The nozzle 4 is situated in a nozzle block 40, in which the actual nozzle mechanism is situated, in order to open and close the nozzle 4 or respectively the nozzle orifice 5 e.g. in the desired manner, or respectively in order to eject the metering substance in the desired manner in the form of small drops. This nozzle block is flanged onto a control block 41, in which the control mechanism is arranged for actuating the closing mechanism in the nozzle block 40. The actuation of the control mechanism can take place for example hydraulically, pneumatically, through piezo elements or suchlike. The metering material is fed to the nozzle 4 via a line 42 (not able to be seen in FIG. 2, but see FIG. 8). Corresponding metering devices 2 with a nozzle 4, which can be used within the scope of the invention, are, however, known to the specialist in the art and therefore do not need to be explained here in detail. To merely name one example of a suitable metering device, reference can be made to DE 10 2011 108 799 A1. The invention is, however, also able to be used on other metering devices.

A guide system 1 is arranged on the metering device 2 illustrated in FIG. 2, so that the nozzle orifice region 6 of the guide system 1 is situated precisely at the position of the nozzle orifice 5. In the close proximity of the nozzle 4 the end regions 14 of the guide ducts 7 are situated, which at the same time also correspond to the end regions of the signal conductors 8, here light conductors 8. They again lie opposite one another here with regard to the nozzle orifice region 6.

At the lower part of the metering device 2 the guide ducts 7 are embodied as milled-out portions or as differently produced recesses in a material block 15 which—as is shown further later with the aid of FIG. 3—can be formed from two material block segments 15u, 150 or respectively material block parts.

The guide ducts 7 run here upwards in a curved line, in the direction of the Z-coordinate, or respectively contrary to the emission direction R, up to a coupling point 24. From this coupling point 24, the light conductors 8 can be introduced, after they have been previously stripped of insulation of the conventional casing M or respectively with their casing removed at their lower end portions which run in the guide ducts. The stripping of insulation takes place here to an extent such that in a portion of the guide ducts 7 facing away from the nozzle orifice region 6, in which portion the diameter is slightly greater than in the remaining portion of the guide ducts 7, a portion of the light conductor casing M can just be inserted.

The light conductors 8 can then be fixed there with their light conductor casing M by means of clamps 17K, to form a strain relief 17. By means of these clamps 17K, the light conductor casings M in the illustrated embodiment can also be separated from the material block 15 again easily and can be drawn out from the guide system together with the light conductors 8, e.g. for exchanging the light conductors 8 or for cleaning. These clamps 17K, which are embodied here as spring-mounted push-buttons 17K can be released easily by a pressure thereon. These push-buttons 17K are secured against falling out by means of a barrier 18. This barrier consists here respectively of a pin 18, which is inserted into a bore running in the region of the clamps 17K parallel to the guide duct 7.

The guide system 1 is connected by a quick coupling arrangement 28, to be explained later in more detail with the aid of FIGS. 5 and 6, in the form of a clamping with a component 40, 41 of the metering device 2, for example the nozzle block 40 and/or the control block 41. The quick coupling arrangement 28 can be actuated in a tool-free manner by means of a knurled screw 19.

As mentioned above, FIG. 3 shows the guide system 1 according to FIG. 2 with a segmented material block 15. In the lower part of the material block 15 in FIG. 3 (the lower material block segment 15u), the guide ducts 7 can be seen which in this two-part form of the material blocks 15 can be easily produced as milled-out portions. Both the lower material block segment 15u and also the upper material block segment 15o are configured so as to be substantially L-shaped, with a lower L leg 15L, which respectively lies, in a mounted state onto the metering device 2, on a lower side of the metering device 2, at which the nozzle orifice 5 is situated, and with an upper L leg, which runs parallel to a front side of the metering device 2, at which the guide system 1 is mounted. The upper material block segment 15o is shaped so that the outer contour of the “L” is adapted to the inner contour of the “L” of the lower material block segment 15u, so that the upper material block segment 15o can be fitted into the lower material block segment 15u.

In the lower, front part or respectively lower L leg 15L of the lower material block segment 15u in FIG. 3, a circular recess can be seen, in the centre of which the nozzle orifice region 6 is drawn. There, the nozzle of the metering device 2 is positioned. In the upper region or respectively upwardly directed L leg of the lower material block segment 15u two large holes can be seen in two lateral portions at which also the light conductors 8 are fed from above, in which holes the clamps 17K (see FIGS. 2 and 4) of the strain relief 17 can be introduced, and in the lower part three holes 20G, 20F which serve for realizing a quick coupling arrangement 28 which is be explained further later. Further holes can also be seen in the segments, which serve for the mounting of the material block segments 15u, 150 on one another, e.g. by means of screws, and which do not have to be explained further in detail.

Also in the upper material block segment 15o in FIG. 3, the nozzle orifice region 6, lying in a recess, in the lower L leg 15L, and the milled-in guide ducts 7 can be seen, in which the light conductors 8 run. These light conductors 8 do not necessarily have to be, but can definitely be part of the guide system 1. In addition, here also holes can be seen for the clamps 17K, at which respectively the casing M of an inserted light conductor 8 terminates. In this upper material block segment 15, the end regions 14 of the guide ducts 7 can also be seen, which lie opposite in relation to the nozzle orifice region 6.

FIG. 4 shows further individual details of this guide system 1 shown in FIGS. 2 and 3, namely the two light conductors 8 arranged into the guide ducts 7 in the material block 15, various individual elements 17K, 17F, 18 of the strain relief 17 and a movable clamping jaw 29 of the already mentioned quick coupling arrangement 28 with the knurled screw 19.

As can be seen here, the light conductors 8 are still provided with their casing M in the upper region, and are already removed of their casing in the lower region by which the light conductors 8 are to be pushed through the guide ducts 7. The end regions 14 of the signal conductors 8, when they are inserted into the material block of FIG. 3, are to correspond to the end regions of the guide ducts 7 in the material block 15.

The clamps 17K of the strain relief 17 and one of the barriers 18 which are to be found in the joined-together material block segments of FIG. 3, can also be readily seen here. The clamps 17K consist here substantially respectively of a push-button 17K in the form of a pin which has two circumferential grooves 17S, 17L beneath a pressure surface onto which an operator can press to release the clamping. The push-buttons 17K are inserted in a pre-stressed manner respectively into a corresponding recess in the material block 15 against a spring 17F. By means of this spring 17F, the push-buttons 17K would be pressed out again from the recess in the material block 15. However, they are secured within the recess in the material block 15 by a pin 18, serving as a barrier 18, engaging into the upper securing groove 17S (directly beneath the pressure surface), which pin is inserted into a corresponding bore parallel to the guide duct 7. The second signal conductor groove 17L running to this upper securing groove 17S is arranged in the region of the guide duct 7 so that a light conductor 8 which is inserted into the guide duct 7 is clamped securely with its casing M in the signal conductor groove 17N when the push-button 17K is pressed by the spring 17F against the pin 18 which is arranged in the upper securing groove 17S. To release the light conductor 8, the push-button 17K only has to be pressed down a little by the operator against the spring force. This mechanism is particularly convenient in order to achieve a sufficient strain relief of the light conductor 8 in the material block 15.

As mentioned, the guide system 1 is advantageously equipped with a quick coupling arrangement 28, in order to couple in a tool-free manner with the metering device 2, here in practice on the nozzle block 40. This quick coupling arrangement 28 can be best explained with the aid of FIGS. 5 and 6.

FIG. 5 shows, for this, the material block 15 with the guide ducts 7 from a similar perspective to FIG. 3, namely viewed from the metering device 1 (not shown here), but in the assembled state of the two material block segments 15u, 15o and with a movable clamping jaw 29 arranged displaceably in a clamping direction K in a guide duct 31 in the material block 15. This guide duct 31 is formed by a cavity adapted to a cross-section of the clamping jaw 29 lying perpendicularly to the clamping direction K, which cavity is situated in the upper side of the material block 15, which points towards the incoming signal conductors 8 (the side arranged above in FIGS. 3 and 5). This cavity is delimited on the side pointing to the metering device 2 by a front wall 32 arranged at the end of the upper L leg of the upper material block segment 150, and to the side pointing away from the metering device 2, by a rear wall 33, which is formed by an upper L leg of the lower material block segment 15u pointing to the incoming signal conductors 8 (see also FIG. 3 in this respect). Between the front wall 32 and the two lateral portions for feeding the light conductors 8 in the upper L leg of the upper material block segment 150, two guide slots 34 are situated for two retaining fingers 29a, 29b or respectively retaining claws of the clamping jaw 29, which are explained further below.

FIG. 6 shows once again the released clamping jaw 29 with the knurled screw 19, which runs (here parallel to the upper portion of the light conductors 8) from top downwards through the clamping jaw 29, freely rotatably in the latter, so that a threaded portion of the knurled screw 19 projects downwards out from the clamping jaw 29 and at the top side (at the upper end) a knurled wheel is situated for actuating the knurled screw 19. Two guide pins 20a extend here, from the underside of the clamping jaw 29, parallel to the threaded portion of the knurled screw 19.

In the base of the cavity in the material block 15, forming the guide duct 31, a threaded hole 20G (or respectively threaded bore) for the thread of the knurled screw 19, and fitting thereto adjacently two guide holes 20F (or respectively guide bores) for the guide pins 20F are introduced approximately centrally. Both the threaded hole 20G and also the guide holes 20F run through the upper material block segment 15o and run into the lower material block segment 15u, here preferably even through the latter. However, the thread of the threaded hole 20G is preferably situated only in the lower material block segment 15u, so that the threaded portion of the knurled screw 19 can slide freely through the upper part of the threaded hole 20G in the upper material block segment 150.

By turning the knurled screw 19, the clamping jaw 29 can therefore be moved to and fro very precisely and finely in the guide channel 31 of the material block 15 parallel to the upper L leg in the clamping direction K, i.e. in the direction of the lower L leg 15L of the material block 15, wherein through the transmission of the rotatory force by means of the knurled screw 19, a relatively great force can be exerted in the clamping direction K. The guide holes 20F interacting with the guide pins 20F provide here for an exact parallel guiding of the clamping jaw 29 in the guide duct 31 of the material block 15.

The movable clamping jaw 29 has, as mentioned, retaining fingers 29a, 29b, which project through guide slots 34 in the lower material block 15 out from the guide duct 31 of the material block 15 substantially parallel to the end-side course of the lower L leg 15L of the material block 15. Between the retaining fingers 29a, 29b of the movable clamping jaw 29 and the lower L leg 15L of the material block 15, which forms an immobile clamping jaw (or respectively a stationary counter-clamping jaw relative to the material block 15), a clamping mechanism is thus formed in the manner of a vice, so that by tightening of the knurled screw 19 a portion of the metering device 2, here the nozzle block 40 of the metering device 2, can be clamped securely therebetween and therefore the entire guide system 1 can be fixed on the metering device 2.

In the case illustrated here, the two retaining fingers 29b engage from above onto the nozzle block 40, wherein one of the retaining fingers 29a is inserted into a slot 43 (which can be seen in FIG. 2 or 8) between the nozzle block 40 and the control block 41. The lower L leg 15L presses here as counter-clamping jaw from below against the nozzle block 40, wherein automatically the nozzle orifice region 6 lies in a fitting manner at the nozzle orifice 5.

The one retaining finger 29a is embodied so as to be relatively thin, in order to fit into the above-mentioned slot 43 between the nozzle block 40 and the control block 41, and the other retaining finger 29b is shaped in order to lie on another position of the nozzle block 40 in a form-fitting manner. Alongside the thin retaining finger 29a, the material of the movable clamping jaw 29 is inclined. The inclination 30 accommodates the given form of the control block.

By means of this quick coupling arrangement 28, both a secure hold of the guide system 1 on the metering device 2 is guaranteed and also an easy exchanging of the guide system 1 is possible, because by a simple turning of the knurled screw 19 the clamping is tightened or released and therefore the guide system 1 can be quickly coupled or uncoupled.

FIG. 7 shows diagrammatically a preferred arrangement of curves 21, 21a in a guide duct 7. This curved guide corresponds to the curved guide in the preferred example embodiment shown with the aid of FIGS. 2 to 4. A guide duct 7 is illustrated, the end region 14 of which can be seen at the bottom in the figure, and the upper end of which is open for the introducing of a signal conductor. The central axis 9 is shown centrally in the guide duct. At the bottom in the figure, the guide duct 7 runs toward the end region 14 firstly in a curve 21 in a first spatial plane 25 which, with an arrangement of the guide duct in a metering device, would stand orthogonally to the emission direction of drops. The course of the guide duct 7 and therefore also the course of its central axis 9 changes with this curve about the angle α, which corresponds here to 90°. In the further course, the guide duct 7 is bent in a further curve 21a in a further spatial plane 26, wherein this further spatial plane 26 stands in an angle γ to the first spatial plane 25, which corresponds here to 90°. The two spatial planes 25, 26 therefore stand orthogonally to one another. The course of the guide duct 7 and therefore also the course of its central axis 9 changes with this further curve 21a about the angle β, which corresponds again here to 90°.

In this way, the alignment of the guide duct 7 changes from a horizontal orientation in the end region 14 by means of two curves 21, 21a into a perpendicular alignment.

FIG. 8 shows in a perspective manner a further preferred embodiment of a guide system 1 on a metering device 2, wherein this can be the same metering device 2 here as in the example embodiment according to FIGS. 2 to 4. In contrast to this other example embodiment, the guide ducts are formed here by pipes 18 without the use of a material block. These pipes 16 can be additionally stabilized by means of stabilizing elements 22 and a stabilizing plate 27. In the lower part, the resulting jetting direction R is illustrated contrary to the Z-axis, on which jetted drops 23 would move.

The stabilizing elements 22 can be formed, at the same time, as a type of strain relief. For example, the casing M of the light conductor could be clamped here again.

The pipes 16 also end directly at the nozzle 4 here, so that the end regions 14 of these guide ducts lie opposite at the nozzle orifice 5 of the nozzle 4 of the metering device 2. At the upper part of the pipes, fixing elements 10 are illustrated, by means of which measuring units of a detection device can be connected with the structure. The pipes could also be embodied at least partially as a Bowden cable, and thereby able to be laid in a flexible manner, wherein preferably the start and the end would be fixed.

FIG. 9, finally, shows another preferred arrangement of curves 36, 36a in guide ducts 7. This curved guide serves in particular for the feeding of particularly fine glass fibre cables, which preferably only have a core diameter of maximally approximately 0.5 mm, particularly preferably approximately 0.3 mm, and an external diameter of approximately 0.7 mm. Accordingly, the guide ducts have an internal diameter of likewise approximately 0.7 mm. The glass fibres are fed here respectively from the direction of one side to the nozzle orifice region 6. Here, also, the guide ducts 7 are situated respectively in a material block (not illustrated) which, however, is configured so as to be relatively flat and extends on both sides adjacent to the nozzle orifice region 6 away beneath the nozzle block (not illustrated in FIG. 9, but illustrated in FIG. 8 in the bottom view with a different guide system). In order to guide the respective guide duct 7 here as close as possible along the underside of the nozzle block, the guide ducts 7 have respectively a slight or respectively flat S-curve-like curve course with respectively two adjacent curves 36, 36a adjoining one another, which extend in a common spatial plane 35. The angle δ of these curves 36, 36a is respectively approximately 16.5°, wherein the curves 36, 36a run in a diametrically opposed manner, so that the central axis 9 of the guide duct 7 before and after the curve course is only slightly offset within the spatial plane 35. In other words, the guide ducts 7 run along laterally closely under the nozzle block towards the nozzle orifice region 6 and run through the curve formation shortly before the nozzle orifice region 6, so that they still run parallel to the underside of the nozzle block towards the nozzle orifice region 6, but at a slightly greater distance from the nozzle block. The length of the guide ducts here is approximately 1 cm. On, for example, the last 0.5 cm, the light conductor can preferably be clamped in the guide, as described above.

In conclusion, it is pointed out once again that the devices which are described above in detail are only example embodiments which can be modified in the most varied of ways by the specialist in the art, without departing from the scope of the invention. For example, a quick coupling device could also be realized without clamping, with e.g. a knurled screw or suchlike, which is used directly for screwing the guide system with the metering device, or a clamping can take place with another mechanism. Furthermore, the use of the indefinite article “a” does not preclude the respective features also being able to be present in multiple numbers. Likewise, the term “unit” does not preclude the latter also consisting of several sub-units, if applicable also separated spatially.

### LIST OF REFERENCE NUMBERS

1 guide system
2 metering device
3 detection device
4 nozzle
5 nozzle orifice
6 nozzle orifice region
7 guide duct
8 signal conductor/light conductor
9 central axis
10 holding element
11 signal transmitting unit
12 signal receiving unit
13 signal evaluating unit
14 end region
15 material block
15L lower L leg
15u lower material block segment
15o upper material block segment
16 pipe
17 strain relief
17K clamp/push button
17F spring
17L signal conductor groove
17S securing groove
18 barrier/pin
19 knurled screw
20a guide pin
20G threaded hole
20F guide hole
21, 21a curve
22 stabilizing elements
23 metering substance
24 coupling point
25 spatial plane
26 spatial plane
27 stabilizing plate
28 quick coupling arrangement
29 movable clamping jaw
29, 29a retaining finger
30 inclination
31 guide duct
32 front wall
33 rear wall
34 guide slot
35 spatial plane
36, 36a curve
40 nozzle block
41 control block
42 line
43 slot
G straight line
M signal conductor casing
K clamping direction
R emission direction
α, β, γ angle
δ angle

1. A guide system for a detection device for monitoring a metering substance coming out of a nozzle orifice of a metering device, wherein a nozzle orifice region for arrangement at the nozzle orifice is associated with the guide system, and the guide system comprises at least one material body, in which at least two guide ducts are formed, which are designed to guide signal conductors to the nozzle orifice region, wherein the end regions of the two guide ducts facing the nozzle orifice region are arranged
with regard to their central axes substantially on a common straight line (G) relative to one another and
with regard to the nozzle orifice region are arranged opposite one another.

2. The guide system according to claim 1, wherein the guide ducts have over their length at least up to the end regions a constant cross-section which preferably has the shape of a regular polygon, an ellipse or a circle, and wherein the guide ducts are preferably configured so that they can serve as hollow conductors.

3. The guide system according to claim 1,
wherein at least a portion of a guide duct is formed as a recess in a material block and/or
at least a portion of a guide duct is present in a pipe,
and preferably here the material block and/or the pipe has a coating on a wall of the guide duct, preferably a coating with a lower frictional resistance and/or with a greater hardness than the base material of the material block or pipe.

4. The guide system according to claim 1, wherein at least one guide duct is stabilized in itself and/or by means of a number of stabilizing elements, so that the end region of the guide duct substantially does not move relative to the nozzle orifice region, and preferably the guide duct also does not deform,
wherein a guide duct is particularly preferably so immobile that, at least in the end region, it is deflected no more than 1 mm in the case of a lateral force of 0.1 N.

5. The guide system according to claim 1, wherein the common straight line (G), on which the end regions of two guide ducts lie with regard to their central axes, is aligned substantially orthogonally to an emission direction (R) as intended, of substance coming out of the nozzle.

6. The guide system according to claim 1, with signal conductors which are arranged in the guide ducts, wherein optical wave guides are preferred as signal conductors,
particularly preferably with one or more of the following characteristics:
an external diameter of between 0.2 to 2.5 mm,
a permissible operating temperature of between −65° C. and 125° C.,
a maximum attenuation of less than 400 dB/km with a wavelength of 650 nm,
a numerical aperture of between 0.3 and 0.7.

7. The guide system according to claim 1, wherein a guide duct, preferably in its end region, has an internal diameter which is more than 0.01 mm greater than the external diameter of the signal conductor used as intended, wherein the preferred internal diameter of the guide ducts is greater than 0.1 mm and/or smaller than 10 mm.

8. The guide system according to claim 1, wherein a guide duct, preferably at its end region, has an internal diameter which is less than 1 mm greater than the external diameter of the signal conductor used as intended,
wherein the end region, facing the nozzle orifice region, of a guide duct, preferably within the last centimetre, has an elastic layer on the inner side of its wall, and the internal diameter of the guide duct preferably corresponds there maximally to the external diameter of the signal conductor as intended.

9. The guide system according to one claim 1 with fixing elements for fastening a signal transmitting unit and a signal receiving unit,
wherein the fixing elements are preferably arranged relative to the guide ducts in such a way that the signal transmitting unit and the signal receiving unit are able to be connected to the respective signal conductors exiting from the guide ducts.

10. The guide system for a detection device for monitoring a substance coming out from a nozzle orifice of a metering device, in particular according to claim 1, wherein the guide system has a nozzle orifice region for arrangement on the nozzle orifice and has at least one material body, in which at least two guide ducts are formed, which are designed to guide signal conductors to the nozzle orifice region,
wherein at least one guide duct has at least two adjacent curves, preferably in a common spatial plane or in two spatial planes which are tilted relative to one another, wherein the two spatial planes are inclined relative to one another preferably in an angle (γ) of between 45° and 135°.

11. The guide system according to claim 10,
wherein in the curves respectively the course of the central axis of the guide duct changes in an angle (α, β, δ) of between 15° and 135°
and/or
wherein the curves lie in two spatial planes, which stand substantially orthogonally relative to one another, and wherein preferably the curve which lies closest to the end region of the guide duct facing the nozzle orifice region, runs in a plane which is aligned at an angle of up to 20°, preferably up to 15°, tilted about the common straight line (G) or orthogonally to the emission direction (R) of substance exiting from the nozzle, and the curve adjacent thereto preferably runs in a plane parallel to this emission direction (R).

12. The guide system according to claim 1, comprising a strain relief for a signal conductor arranged in the guide duct, preferably for the clamping of a casing (M) of the signal conductor,
and/or
a quick coupling arrangement, preferably able to be actuated in a tool-free manner, for mounting the guide system on further components of a metering device, preferably comprising a clamping arrangement for clamping the guide system on the further components of the metering device.

13. A detection device for monitoring a substance coming out of a nozzle orifice of a metering device, wherein the detection device has a signal transmitting unit, a signal receiving unit and a signal evaluating unit and the guide system according to claim 1.

14. A metering device, comprising a nozzle with a nozzle orifice and the guide system according to claim 1.

15. A method for configuring a detection device for monitoring a substance coming out of a nozzle orifice of a metering device, comprising at least the steps:
providing the guide system, in particular according to claim 1, wherein a nozzle orifice region for arrangement at a nozzle orifice of the metering device is associated with the guide system, and wherein the guide system comprises at least one material body, in which at least two guide ducts are formed, which are designed to guide signal conductors to the nozzle orifice region,
inserting at least two signal conductors into the guide ducts of the guide system,
connecting the end of one of the signal conductors, facing away from the nozzle, with a signal transmitting unit,
connecting the end of another of the signal conductors, facing away from the nozzle with a signal receiving unit.

16. A metering device, comprising a nozzle with a nozzle orifice and the detection device according to claim 13.
